(19) United States
(12) Patent Application Publication
(10) Pub. No.: US 2024/0276366 A1
(43) Pub. Date: Aug. 15, 2024

(54) PROCESSING APPARATUS, PROCESSING METHOD, AND NON-TRANSITORY COMPUTER-READABLE RECORDING MEDIUM

(71) Applicant: NEC Corporation, Tokyo (JP)

(72) Inventor: Kohei Izui, Tokyo (JP)

(73) Assignee: NEC Corporation, Tokyo (JP)

(21) Appl. No.: 18/425,031

(22) Filed: Jan. 29, 2024

(30) Foreign Application Priority Data
Feb. 9, 2023 (JP) 2023-018578

(51) Int. Cl. H04W 52/02; H04W 28/08

(52) U.S. Cl. CPC H04W 52/0206; H04W 28/08

(57) ABSTRACT

A processing apparatus determines a reward to provide to a terminal apparatus that performs target processing, which is processing contributive to a reduction in power consumption in a communication system using a base station, according to assignment from the base station, and provides the determined reward.

### CROSS-REFERENCE TO RELATED APPLICATIONS

This application is based upon and claims the benefit of priority from Japanese Patent Application No. 2023-018578, filed on Feb. 9, 2023, the disclosure of which is incorporated herein in its entirety by reference.

### TECHNICAL FIELD

The present invention relates to a processing apparatus, a processing method, and a recording medium.

### BACKGROUND ART

Various techniques relating to wireless communication are known.

For example, Patent Literature 1 discloses a method for offloading backhaul traffic. According to Patent Literature 1, a first base station receives an indication indicating backhaul traffic offloading for a wireless transmit/receive unit (WTRU) that is associated with the first base station from a network. Subsequently, the first base station selects a second base station based on at least the capacity of a link between the first base station and the second base station, the type of the above-described backhaul traffic, or a fairness index parameter. Then, the first base station establishes a wireless connection with the second base station. After that, the first base station offloads at least one bearer of the WTRU, such that the offloaded bearer is routed to and from the WTRU via the second base station and the above-described first base station.

### CITATION LIST

### Patent Literature

[Patent Literature 1] Japanese Patent Application Laid-Open No. 2016-213906

### SUMMARY OF INVENTION

### Technical Problem

According to sophistication of base stations and an increase in the number of installed base stations, an influence of power consumption of an entire base station system on the environment is increasingly problematic. To deal with such a problem, just offloading the backhaul traffic as described in Patent Literature 1 is not sufficient, and one desirable measure against it is to reduce a load on the base station by distribution processing of causing a terminal side to undertake at least a part of processing supposed to be performed by the base station, processing that assists the base station, or the like. However, under the current circumstances, this measure fails to bring about a sufficient merit worth an increase in the power consumption that the terminal side undergoes due to the execution of this processing, and involves a problem with active implementation thereof. In this manner, a problem arises in that it is difficult to appropriately reduce the load on the base station.

In light thereof, one of objects of the present invention is to provide a processing apparatus, a processing method, and a recording medium capable of solving the above-described problem.

### Solution to Problem

To achieve such an object, according to one aspect of the present disclosure, a processing apparatus includes
at least one memory configured to store processing instructions; and
at least one processor configured to execute the processing instructions to:
determine a reward to provide to a terminal apparatus that performs target processing, which is processing contributive to a reduction in power consumption in a communication system using a base station, according to assignment from the base station, and provide the determined reward.

Further, according to another aspect of the present disclosure, a processing method configured to be performed by an information processing apparatus includes
determining a reward to provide to a terminal apparatus that performs target processing, which is processing contributive to a reduction in power consumption in a communication system using a base station, according to assignment from the base station, and providing the determined reward.

Further, according to another aspect of the present disclosure, a non-transitory computer-readable recording medium records thereon a program for causing an information processing apparatus to realize processing including:
determining a reward to provide to a terminal apparatus that performs target processing, which is processing contributive to a reduction in power consumption in a communication system using a base station, according to assignment from the base station, and providing the determined reward.

### Advantageous Effects of Invention

According to each of the above-described configurations, the above-described object can be achieved.

### BRIEF DESCRIPTION OF DRAWINGS

FIG. 1 is a diagram illustrating an example of the configuration of a communication system according to a first exemplary embodiment of the present disclosure.

FIG. 2 is a diagram illustrating an example of the configuration of a base station.

FIG. 3 is a diagram illustrating one example of assignment processing.

FIG. 4 is a diagram illustrating an example of the configuration of a terminal apparatus.

FIG. 5 is a sequence diagram illustrating an example of an operation of the base station and the terminal apparatus.

FIG. 6 is a diagram illustrating another example of the configuration of the communication system.

FIG. 7 is a diagram illustrating an example of the hardware configuration of a processing apparatus according to a second exemplary embodiment of the present disclosure.

FIG. 8 is a block diagram illustrating an example of the configuration of the processing apparatus.

### DESCRIPTION OF EMBODIMENTS

### First Exemplary Embodiment

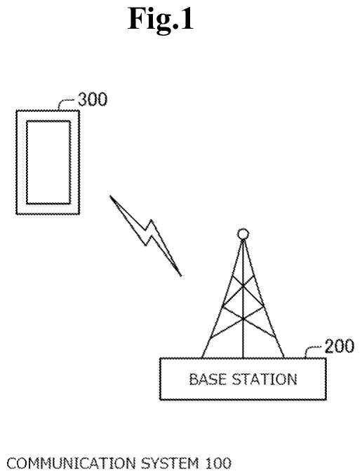

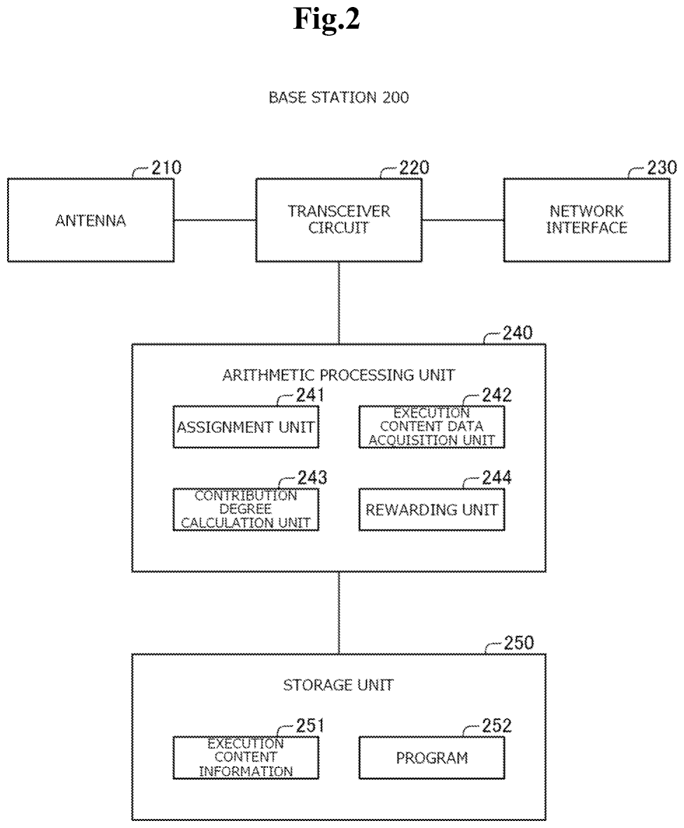

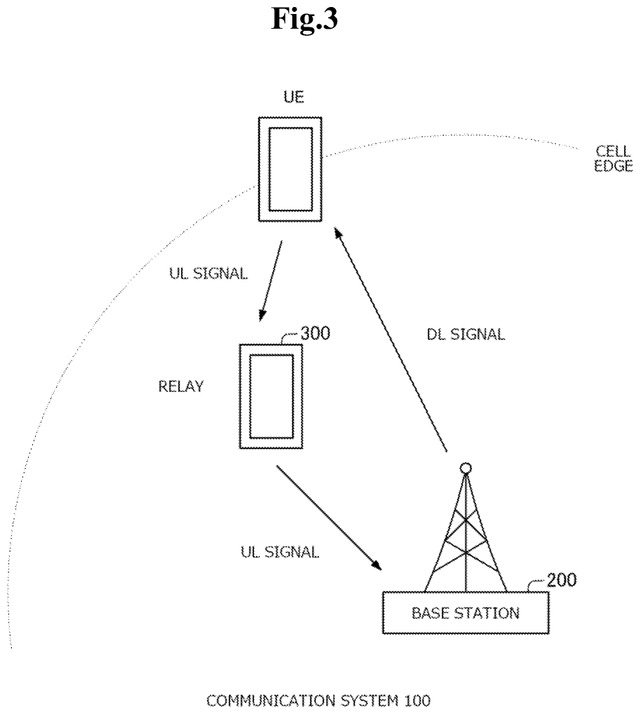

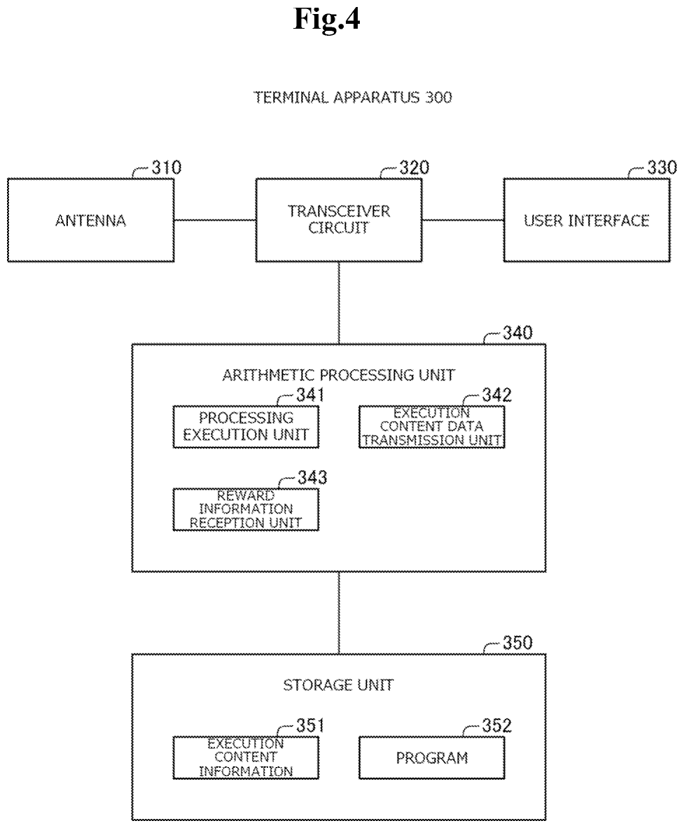

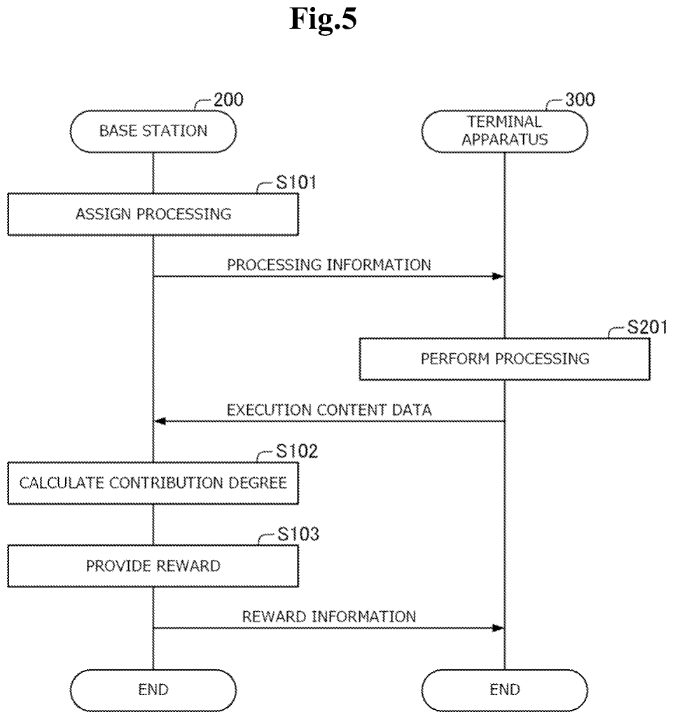

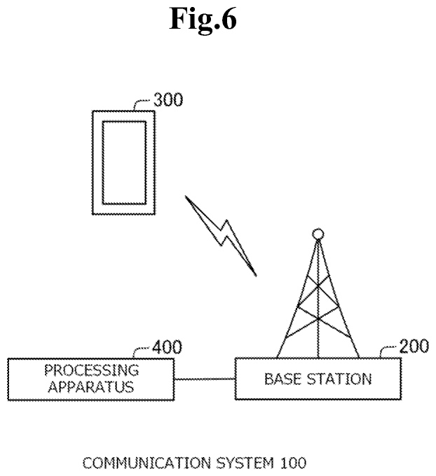

A first exemplary embodiment of the present disclosure will be described with reference to FIGS. 1 to 6. FIG. 1 is a diagram illustrating an example of the configuration of a communication system 100. FIG. 2 is a diagram illustrating an example of the configuration of a base station 200. FIG. 3 is a diagram illustrating one example of assignment processing. FIG. 4 is a diagram illustrating an example of the configuration of a terminal apparatus 300. FIG. 5 is a sequence diagram illustrating an example of an operation of the base station 200 and the terminal apparatus 300. FIG. 6 is a diagram illustrating another example of the configuration of the communication system 100.

The first exemplary embodiment of the present disclosure will be described with respect to a base station 200, which assigns target processing to a terminal apparatus 300 to cause the terminal apparatus 300 to perform it. The target processing is processing contributive to a reduction in power consumption in the entire communication system 100 or the base station 200 by causing the terminal apparatus 300 to perform it. As will be described below, the base station 200 assigns the target processing to the terminal apparatus 300 to cause the terminal apparatus 300 to perform it according to a predetermined condition or the like. Further, the base station 200 provides a predetermined reward to the terminal apparatus 300 that performs the above-described target processing. Due to that, the base station 200 realizes positive undertaking of the execution of the target processing by the terminal apparatus 300.

Further, the base station 200 can be configured to calculate a contribution degree indicating how large contribution the terminal apparatus 300 makes by performing the target processing. The contribution degree can be calculated according to, for example, the heaviness of a load imposed on the terminal apparatus 300 side when the assigned target processing is performed, and/or a merit on the base station 200 side derived from the assignment of the target processing such as a reduction in the power consumption, a load, and/or consumable communication resources. The base station 200 may provide the reward according to the calculated contribution degree to the terminal apparatus 300.

Note that the above-described target processing may be processing supposed to be performed by the base station 200 itself or may be processing that allows the terminal apparatus 300 to assist the base station 200 by causing the terminal apparatus 300 to perform it. In other words, the base station 200 may assign a part of the processing supposed to be performed by the base station 200 to the terminal apparatus 300, or may assign the processing that assists the base station 200 to the terminal apparatus 300. More specifically, for example, the target processing includes various kinds of processing that contribute to a reduction in the power consumption in the base station 200 or a reduction in the power consumption in the entire communication system 100 by causing the terminal apparatus 300 to perform it. As one example, the target processing may be, for example, UL (uplink) relay processing for cell-edge UE (User Equipment). Normally, transmission power is low in UL compared to DL (downlink), and cell-edge UE may fail to establish a connection for UL even if succeeding in establishing a connection for DL. Therefore, upon detecting cell-edge UE, the base station 200 assigns the UL relay processing to the terminal apparatus 300 to cause the terminal apparatus 300 to perform it. Due to that, the base station 200 can cause the terminal apparatus 300 located closer to the base station 200 to relay UL of the cell-edge UE. This can result in, for example, a reduction in unnecessary retransmission resources, thereby realizing low power consumption. Further, the above-described configuration substantially leads to area expansion, thereby being able to reduce the number of base stations 200 and thus realize power saving of the entire communication system 100 as a result thereof.

Note that the target processing is not limited to the above-described example. The target processing may include processing different from the above-described example that is contributive to a reduction in the power consumption in the base station 200.

FIG. 1 illustrates an example of the configuration of the communication system 100 according to the present disclosure. Referring to FIG. 1, the communication system 100 includes the base station 200 and the terminal apparatus 300. The base station 200 and the terminal apparatus 300 can communicate with each other using, for example, E-UTRA (Evolved Universal Terrestrial Radio Access) or the 5G wireless access technology (RAT: Radio Access Technology). Note that the configuration of the communication system 100 is not limited to the example illustrated in FIG. 1. For example, the communication system 100 may include a plurality of base stations 200 and/or may include a plurality of terminal apparatuses 300.

The base station 200 is a processing apparatus that carries out wireless communication with the terminal apparatus 300, another UE, and the like. For example, the base station 200 may be a gNB (gNodeB) in 5G. The base station 200 may be a communication apparatus different from the above-described example, such as an eNB (eNodeB).

In the case of the present disclosure, the base station 200 may be configured of one device or may be configured of a plurality of devices. The base station 200 may be configured of, for example, one or a plurality of RU(s) (Radio Unit(s)), and a server device that is a processing device having a function such as a DU (Distributed Unit), a CU (Central Unit), and the like. Further, the function as the above-described server device may be realized on a cloud.

FIG. 2 illustrates an example of the configuration of the base station 200. Referring to FIG. 2, for example, the base station 200 includes an antenna 210, a transceiver circuit 220, a network interface 230, an arithmetic processing unit 240, and a storage unit 250. The base station 200 may be configured in a manner different from the above-described example.

The antenna 210 transmits and receives a radio wave between the base station 200, and the terminal apparatus 300, another UE, and the like. The antenna 210 may be a commonly-used antenna such as an antenna realized by, for example, mounting an antenna element on a board.

The transceiver circuit 220 operates so as to transmit and receive a signal between the base station 200, and the terminal apparatus 300, another UE, and the like connected via one or a plurality of antenna(s) 210. Further, the transceiver circuit 220 can transmit and receive a signal between the base station 200 and another network node via the network interface 230.

The arithmetic processing unit 240 includes an arithmetic device such as a CPU (Central Processing Unit) and a peripheral circuit thereof. The arithmetic processing unit 240 controls the operation of the base station 200 by reading in a program 252 from the storage unit 250 and executing it. For example, the arithmetic processing unit 240 processes signaling between the base station 200, and the terminal apparatus 300, another UE, another network node, and the like. The signaling may include signaling possessed by the commonly-used base station 200, such as a signaling message regarding connection establishment and retention regarding a wireless connection and a location procedure.

Further, the arithmetic processing unit 240 causes the above-described hardware and the program 252 to cooperate with each other to realize various kinds of processing units characteristic of the present disclosure by reading in the program 252 from the storage unit 250 and executing it. Main processing units realized by the arithmetic processing unit 240 include, for example, an assignment unit 241, an execution content data acquisition unit 242, a contribution degree calculation unit 243, and a rewarding unit 244.

The assignment unit 241 assigns the target processing to the terminal apparatus 300 to cause the terminal apparatus 300 to perform it according to the predetermined condition or the like. For example, when UE is present on a cell edge, the assignment unit 241 assigns the UL relay processing to the terminal apparatus 300 to cause the terminal apparatus 300 to perform it. The assignment unit 241 may assign the target processing different from the above-described example according to a condition different from the above-described example.

FIG. 3 illustrates one example of the assignment of the target processing by the assignment unit 241. Referring to FIG. 3, the assignment unit 241 searches for the terminal apparatus 300 satisfying a predetermined condition if it is determined that UE is present on a cell edge based on the positional information of the UE or the like. At this time, the assignment unit 241 may search for only one terminal apparatus 300 or may search for a plurality of terminal apparatuses 300. As one example, the assignment unit 241 has information indicating the position of the terminal apparatus 300, or the like. Then, the assignment unit 241 searches for the terminal apparatus 300 based on the information indicating the position of the terminal apparatus 300. For example, the assignment unit 241 searches for the terminal apparatus 300 satisfying the condition based on at least one or a combination of conditions according to the position of the terminal apparatus 300, such as a condition that the distance between the base station 200 and the terminal apparatus 300 is a predetermined value or shorter, a condition that the distance between the UE present on the cell edge and the terminal apparatus 300 is a predetermined value or shorter, and a condition that the distance between the base station 200 and the terminal apparatus 300 is shorter than the distance between the UE present on the cell edge and the terminal apparatus 300. The assignment unit 241 may also search for the terminal apparatus 300 additionally based on a condition different from the above-described examples, such as a condition that the terminal apparatus 300 is a preregistered terminal apparatus 300, a condition that the assigned target processing is determined to be able to be performed based on preregistered information, and a condition that permission indicating acceptance of the assignment of the target processing is acquired from the terminal apparatus 300.

Further, the assignment unit 241 transmits processing information including an instruction to perform the target processing, various kinds of information necessitated to perform the target processing, and the like to the searched terminal apparatus 300. For example, the assignment unit 241 transmits processing information including various kinds of information necessitated to perform the UL relay processing along with an instruction to perform the UL relay processing. The assignment unit 241 may transmit, for example, information indicating a transmission source and a transmission destination to perform the UL relay processing therebetween as the processing information.

The execution content data acquisition unit 242 acquires execution content data, which is data that can be acquired when or after the target processing is performed, from the terminal apparatus 300 to which the target processing is assigned. For example, the execution content data acquisition unit 242 acquires load data indicating the load on the terminal apparatus 300 when the target processing is performed, such as information indicating the number of packets or the data volume that the terminal apparatus 300 relays when performing the UL relay processing, or the time taken to perform the relay processing, from the terminal apparatus 300 as the execution content data. The execution content data acquisition unit 242 may acquire data different from the above-described examples according to the target processing performed by the terminal apparatus 300 as the execution content data. Further, the execution content data acquisition unit 242 stores the acquired execution content data into the storage unit 250 as execution content information 251.

The contribution degree calculation unit 243 calculates a contribution degree indicating how large contribution is made to a reduction in the power consumption by the terminal apparatus 300 based on the execution content data acquired by the execution content data acquisition unit 242.

For example, the contribution degree calculation unit 243 may calculate the contribution degree using any predetermined equation. As one example, the contribution degree calculation unit 243 calculates the contribution degree in such a manner that the contribution degree has a larger value according to an increase in the number of packets or the data volume relayed when the UL relay processing is performed. Alternatively, the contribution degree calculation unit 243 can calculate the contribution degree in such a manner that the contribution degree has a larger value according to an increase in the time taken to perform the relay processing. The contribution degree calculation unit 243 may estimate the amount of a reduction in the power consumption of the entire communication system 100 or the load based on the execution content data, and calculate the contribution degree according to the estimated result. Note that the above-described estimation may be realized using any method, such as using a model trained in advance.

The rewarding unit 244 provides a predetermined reward to the terminal apparatus 300 that performs the target processing. For example, the rewarding unit 244 may be configured to determine the reward to provide based on the contribution degree calculated by the contribution degree calculation unit 243, and provide the determined reward. Further, the rewarding unit 244 can transmit reward information indicating the content of the determined reward or the reward itself to the terminal apparatus 300 as necessary.

For example, the rewarding unit 244 can provide at least a part of rewards like the following examples to the terminal apparatus 300. The rewarding unit 244 may be configured to provide a greater reward as the contribution degree increases.

### Communication Priority

Prioritize the terminal apparatus 300 that performs the target processing to allocate a bandwidth, such as presenting more communication chances or guaranteeing a predetermined communication rate compared to the terminal apparatus 300 other than the terminal apparatus 300 that performs the target processing, another UE, and the like.

### Discount of Charge

Discount or waive the charge.

### Communication Volume

Grant a privilege to allow the terminal apparatus 300 to carry out data communication by a predetermined volume or during a predetermined period.

### Cash or the Like

Offer cash, virtual currency, electronic money, or a value worth them.

### Benefit in Kind or Experience

Offer a predetermined benefit in kind useful for the terminal apparatus 300 or a user thereof, an invitation code to such a benefit, or the like.

Note that the rewarding unit 244 may be configured to determine the reward independently of the contribution degree. For example, the rewarding unit 244 may determine the reward according to the type of the assigned target processing, or may determine the reward according to the type of the terminal apparatus 300, a content agreed in advance between the base station 200 and the terminal apparatus 300, and/or the like. For example, the rewarding unit 244 may possess in advance information that indicates the type of the target processing according to, for example, the heaviness of the load predicted to be imposed on the terminal apparatus 300 when the target processing is performed and/or the content of processing necessitated when the target processing is performed, and the content of the reward in association with each other, and determine the reward according to the type by referring to this information. The rewarding unit 244 may determine the reward by combining at least a part of the above-described exemplary items and the contribution degree.

This is an example of the configuration of the arithmetic processing unit 240. Note that the arithmetic processing unit 240 may include, for example, a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, or a micro controller, or a combination thereof, instead of the above-described CPU.

The storage unit 250 is a storage device such as a hard disk or a memory. The storage unit 250 stores processing information required for various kinds of processing performed by the arithmetic processing unit 240, and the program 252 therein. The program 252 realizes the various kinds of processing units by being read in and executed by the arithmetic processing unit 240. The program 252 is read in from an external apparatus or a recording medium in advance via a data input/output function such as the antenna 210 or the network interface 230, and is stored in the storage unit 250. Examples of main information stored in the storage unit 250 include the execution content information 251.

The execution content information 251 includes the execution content data, which is the data that can be acquired when or after the target processing is performed by the terminal apparatus 300. The execution content information 251 includes, for example, the information indicating the number of packets or the data volume that the terminal apparatus 300 relays when performing the UL relay processing, or the time taken to perform the relay processing as the execution content data. The execution content information 251 may include various kinds of data different from the above-described examples. For example, the execution content information 251 is updated according to, for example, the acquisition of the execution content data from the terminal apparatus 300 by the execution content data acquisition unit 242.

The base station 200 is configured in the above-described manner as one example. Note that the assignment of the target processing and the transmission/reception of the execution content data between the base station 200 and the terminal apparatus 300 may be carried out using, for example, a control channel such as a PDCCH (Physical Downlink Control CHannel)/PUCCH (Physical Uplink Control CHannel) or a data channel such as a PDSCH (Physical Downlink Shared CHannel)/PUSCH (Physical Uplink Shared CHannel). The processing regarding the above-described transmission/reception may be performed in a higher layer than the PDCCH/PUCCH or the like, such as an application layer.

Note that the configuration of the base station 200 is not limited to the above-described example. For example, the base station 200 may be unequipped with the execution content data acquisition unit 242, the contribution degree calculation unit 243, and/or the like.

The terminal apparatus 300 is a communication apparatus that carries out wireless communication with the base station 200 and the like. For example, the terminal apparatus 300 may be one of a smartphone, a tablet terminal, an IoT (Internet of Things) device, any other UE, and the like.

FIG. 4 illustrates an example of the configuration of the terminal apparatus 300. Referring to FIG. 4, for example, the terminal apparatus 300 includes an antenna 310, a transceiver circuit 320, a user interface 330, an arithmetic processing unit 340, and a storage unit 350. The terminal apparatus 300 may be configured in a manner different from the above-described example.

The antenna 310 transmits and receives a radio wave between the terminal apparatus 300, and the base station 200 and the like. The antenna 310 may be a commonly-used antenna such as an antenna realized by, for example, mounting an antenna element on a board.

The transceiver circuit 320 operates so as to transmit and receive a signal between the terminal apparatus 300 and a node such as the base station 200 connected via one or a plurality of antenna(s) 310. Further, the transceiver circuit 320 can receive an input and the like from an operator operating the terminal apparatus 300 via a configuration included in a commonly-used mobile device, such as the user interface 330.

The arithmetic processing unit 340 includes an arithmetic device such as a CPU and a peripheral circuit thereof. The arithmetic processing unit 340 controls the operation of the terminal apparatus 300 by reading in a program 352 from the storage unit 350 and executing it. Further, the arithmetic processing unit 340 can cause the above-described hardware and the program 352 to cooperate with each other to realize various kinds of processing units characteristic of the present disclosure by reading in the program 352 from the storage unit 350 and executing it. Examples of main processing units realized by the arithmetic processing unit 340 include a processing execution unit 341, an execution content data transmission unit 342, and a reward information reception unit 343.

The processing execution unit 341 performs the target processing assigned from the base station 200. For example, the processing execution unit 341 performs the UL relay processing of transmitting a UL signal received from the UE to the base station 200. In other words, when it is determined that the UL signal targeted for the relay processing is received from the UE based on, for example, the processing information received from the base station 200, the processing execution unit 341 transmits the received UL signal to the base station 200 based on, for example, the processing information. Note that the processing execution unit 341 may perform the target processing different from the above-described example.

Further, when performing the above-described target processing or after the end of the target processing, the processing execution unit 341 acquires the execution content data, which is the data that can be acquired due to the execution of the target processing, and also stores the acquired execution content data into the storage unit 350 as execution content information 351. For example, the processing execution unit 341 stores data such as the information indicating the number of relayed packets or data volume, or the time taken to perform the relay processing into the storage unit 350 as the execution content information 351.

The execution content data transmission unit 342 transmits the execution content data stored in the storage unit 350 as the execution content information 351 to the base station 200. The execution content data transmission unit 342 may transmit the execution content data to the base station 200 at any timing such as when the processing execution unit 341 ends the execution of the target processing.

The reward information reception unit 343 receives the reward information transmitted from the base station 200 when the base station 200 transmits the reward information to the terminal apparatus 300. The reward information reception unit 343 may store the received reward information into the storage unit 350 or the like.

This is an example of the configuration of the arithmetic processing unit 340. Note that the arithmetic processing unit 340 may include a GPU or the like instead of a CPU similarly to the arithmetic processing unit 240 included in the above-described base station 200.

The storage unit 350 is a storage device such as a hard disk or a memory. The storage unit 350 stores processing information required for various kinds of processing performed by the arithmetic processing unit 340, and the program 352 therein. The program 352 realizes the various kinds of processing units by being read in and executed by the arithmetic processing unit 340. The program 352 is read in from an external apparatus or a recording medium in advance via a data input/output function such as the antenna 310 or the user interface 330, and is stored in the storage unit 350. Examples of main information stored in the storage unit 350 include the execution content information 351.

The execution content information 351 includes the execution content data, which is the data acquired when or after the processing execution unit 341 performs the target processing. The execution content information 351 includes, for example, the information indicating the number of packets or the data volume relayed when the UL relay processing is performed, or the time taken to perform the relay processing as the execution content data. The execution content information 351 may include data according to the content of the performed target processing that is different from the above-described examples. For example, the execution content information 351 is updated according to, for example, the execution of the target processing by the processing execution unit 341.

In the case of the present disclosure, the terminal apparatus 300 is configured in the above-described manner. Note that the configuration of the terminal apparatus 300 is not limited to the above-described example. For example, the terminal apparatus 300 may be unequipped with the execution content data transmission unit 342, the reward information reception unit 343, and/or the like.

Subsequently, an example of an operation of the base station 200 and the terminal apparatus 300 will be described with reference to FIG. 5. FIG. 5 is a sequence diagram illustrating the example of the operation of the base station 200 and the terminal apparatus 300. Referring to FIG. 5, the assignment unit 241 assigns the target processing to the terminal apparatus 300 to cause the terminal apparatus 300 to perform it according to the predetermined condition or the like (step S101). For example, when the predetermined condition is satisfied, the assignment unit 241 searches for the terminal apparatus 300 to assign the target processing. Further, the assignment unit 241 transmits the processing information including the instruction to perform the target processing, the various kinds of information necessitated to perform the target processing, and the like to the searched terminal apparatus 300.

The processing execution unit 341 performs the target processing assigned from the base station 200 (step S201). The processing execution unit 341 may perform the target processing using any method. Further, the execution content data transmission unit 342 transmits the execution content data to the base station 200 when, for example, the processing execution unit 341 ends the execution of the target processing.

The execution content data acquisition unit 242 acquires the execution content data. Further, the contribution degree calculation unit 243 calculates the contribution degree indicating how large contribution is made to a reduction in the power consumption by the terminal apparatus 300 based on the execution content data acquired by the execution content data acquisition unit 242 (step S102).

The rewarding unit 244 provides the predetermined reward to the terminal apparatus 300 that performs the target processing (step S103). For example, the rewarding unit 244 determines the reward to provide based on the contribution degree calculated by the contribution degree calculation unit 243, and provides the determined reward. Further, the rewarding unit 244 can transmit the reward information indicating the content of the determined reward or the reward itself to the terminal apparatus 300.

This is the example of the operation of the base station 200 and the terminal apparatus 300.

In this manner, the base station 200 includes the assignment unit 241 and the rewarding unit 244. According to such a configuration, the rewarding unit 244 can provide the predetermined reward to the terminal apparatus 300 that performs the target processing. As a result, the base station 200 can realize the positive undertaking of the execution of the target processing by the terminal apparatus 300. Due to that, the base station 200 can cause the terminal apparatus 300 to positively undertake the execution of the target processing, thereby appropriately reducing the load on the base station 200 as a result thereof.

Further, the base station 200 includes the contribution degree calculation unit 243. According to such a configuration, the rewarding unit 244 can provide the reward according to the contribution degree calculated by the contribution degree calculation unit 243. As a result, the base station 200 can provide a further appropriate reward, thereby further appropriately realizing the positive undertaking of the execution of the target processing by the terminal apparatus 300.

Note that the configuration of the communication system 100 is not limited to the above-described example. For example, FIG. 6 illustrates another example of the configuration of the communication system 100. Referring to FIG. 6, the communication system 100 may include a processing apparatus 400 besides the base station 200 and the terminal apparatus 300.

The processing apparatus 400 is an information processing apparatus that has functions as the contribution degree calculation unit 243 and the rewarding unit 244 in the configuration of the base station 200 exemplarily illustrated in FIG. 2. For example, the processing apparatus 400 includes an arithmetic device such as a CPU and a storage device. The processing apparatus 400 can realize each of the above-described processing units through execution of a program stored in the storage device by the arithmetic device. Note that, in the case where the communication system 100 includes the processing apparatus 400, the base station 200 may be unequipped with the functions according to the configuration included in the processing apparatus 400.

### Second Exemplary Embodiment

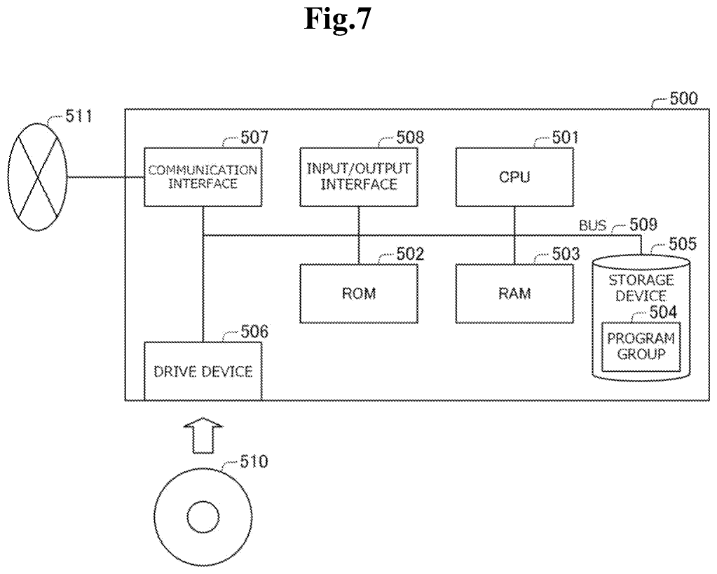

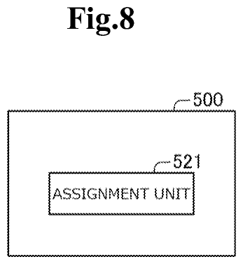

Next, a second exemplary embodiment of the present disclosure will be described with reference to FIGS. 7 and 8. FIG. 7 is a diagram illustrating an example of the hardware configuration of a processing apparatus 500. FIG. 8 is a block diagram illustrating an example of the configuration of the processing apparatus 500.

The second exemplary embodiment of the present disclosure will be described with respect to the example of the configuration of the processing apparatus 500. FIG. 7 illustrates the example of the hardware configuration of the processing apparatus 500. Referring to FIG. 7, the processing apparatus 500 has the following hardware configuration as one example.
CPU (Central Processing Unit) 501 (arithmetic device)
ROM (Read Only Memory) 502 (storage device)
RAM (Random Access Memory) 503 (storage device)
Program group 504 to be loaded into the RAM 503
Storage device 505 storing therein the program group 504
Drive device 506 that performs reading and writing on a recording medium 510 outside the information processing apparatus
Communication interface 507 connected to a communication network 511 outside the information processing apparatus
Input/output interface 508 that inputs and outputs data
Bus 509 connecting each constituent element

Further, the processing apparatus 500 can realize a function as a rewarding unit 521 illustrated in FIG. 8 through acquisition of the program group 504 by the CPU 501 and execution thereof by this CPU 501. Note that the program group 504 is, for example, stored in the storage device 505 or the ROM 502 in advance, and loaded into the RAM 503 or the like and executed by the CPU 501 as needed. Alternatively, the program group 504 may be supplied to the CPU 501 via the communication network 511, or may be stored in the recording medium 510 in advance and read out by the drive device 506 and supplied to the CPU 501.

Note that FIG. 7 illustrates the example of the hardware configuration of the processing apparatus 500. The hardware configuration of the processing apparatus 500 is not limited to the above-described example. For example, the processing apparatus 500 may be configured of a part of the above-described configuration, such as a configuration not including the drive device 506. Further, the CPU 501 may be, for example, a GPU exemplarily described in the first exemplary embodiment.

The rewarding unit 521 provides a predetermined reward to a terminal apparatus that performs target processing, which is processing contributive to a reduction in power consumption in a communication system using a base station, according to assignment from the above-described base station.

In this manner, the processing apparatus 500 includes the rewarding unit 521. According to such a configuration, the rewarding unit 521 can provide the predetermined reward to the terminal apparatus that performs the target processing according to the assignment from the base station. As a result, the processing apparatus 500 can realize the positive undertaking of the execution of the target processing by the terminal apparatus. Due to that, the processing apparatus 500 can cause the terminal apparatus to positively undertake the execution of the target processing, thereby appropriately reducing a load on the base station as a result thereof.

Note that the above-described processing apparatus 500 can be realized by incorporating a predetermined program into an information processing apparatus such as this processing apparatus 500. More specifically, a program according to another aspect of the present invention is a program for causing an information processing apparatus such as the processing apparatus 500 to realize processing including determining a reward to provide to a terminal apparatus that performs target processing, which is processing contributive to a reduction in power consumption in a communication system using a base station, according to assignment from the base station, and providing the determined reward.

Further, a processing method configured to be performed by an information processing apparatus such as the above-described processing apparatus 500 is a method including determining a reward to provide to a terminal apparatus that performs target processing, which is processing contributive to a reduction in power consumption in a communication system using a base station, according to assignment from the base station, and providing the determined reward.

Even the invention of the program or a non-transitory computer-readable recording medium recording the program, or the processing method configured in the above-described manner can also bring about functions and advantageous effects similar to the above-described processing apparatus 500, thereby achieving the above-described object of the present disclosure.

### SUPPLEMENTARY NOTES

A part or whole of the above-described exemplary embodiments can also be described as, but not limited to, the following supplementary notes. Hereinafter, outlines of the processing apparatus and the like according to the present invention will be described. However, the present invention is not limited to the following configurations.

### (Supplementary Note 1)

A processing apparatus comprising:
a rewarding unit configured to provide a predetermined reward to a terminal apparatus that performs target processing, which is processing contributive to a reduction in power consumption in a communication system using a base station, according to assignment from the base station.

### (Supplementary Note 2)

The processing apparatus according to supplementary note 1, further comprising:
an assignment unit configured to assign the target processing to the terminal apparatus;
wherein the rewarding unit provides the predetermined reward to the terminal apparatus that performs the assigned target processing.

### (Supplementary Note 3)

The processing apparatus according to supplementary note 2, wherein
the assignment unit assigns processing that assists the base station by being performed by the terminal apparatus as the target processing.

### (Supplementary Note 4)

The processing apparatus according to supplementary note 2 or 3, wherein
the assignment unit assigns processing for relaying a UL (uplink) signal from UE (User Equipment) present on a cell edge as the target processing.

### (Supplementary Note 5)

The processing apparatus according to any one of supplementary notes 2 to 4, wherein
the rewarding unit provides the reward according to a type of the target processing assigned by the assignment unit.

### (Supplementary Note 6)

The processing apparatus according to any one of supplementary notes 1 to 5, further comprising:
a calculation unit configured to calculate a contribution degree indicating how large contribution the terminal apparatus makes by performing the target processing based on data acquired when the terminal apparatus performs the target processing,
wherein
the rewarding unit provides the reward according to the contribution degree calculated by the calculation unit.

### (Supplementary Note 7)

The processing apparatus according to supplementary note 6, further comprising:
an acquisition unit configured to acquire execution content data, the execution content data being data that can be acquired from the terminal apparatus when the target processing is performed,
wherein
the calculation unit calculates the contribution degree based on the data acquired by the acquisition unit.

### (Supplementary Note 8)

The processing apparatus according to supplementary note 7, wherein
the acquisition unit acquires load information, which indicates a load on the terminal apparatus that is imposed when the target processing is performed, from the terminal apparatus as the execution content data.

### (Supplementary Note 9)

A processing method configured to be performed by an information processing apparatus, the processing method comprising:
determining a reward to provide to a terminal apparatus that performs target processing, which is processing contributive to a reduction in power consumption in a communication system using a base station, according to assignment from the base station, and providing the determined reward.

### (Supplementary Note 10)

A program for causing an information processing apparatus to realize processing comprising:
determining a reward to provide to a terminal apparatus that performs target processing, which is processing contributive to a reduction in power consumption in a communication system using a base station, according to assignment from the base station, and providing the determined reward.

Note that the program disclosed in each of the above-described exemplary embodiments and the supplementary notes is, for example, stored in a storage device or recorded in a computer-readable recording medium. For example, the recording medium is a portable medium such as a flexible disk, an optical disk, a magneto-optical disk, or a semiconductor memory.

Having described the present invention with reference to each of the above-described exemplary embodiments, the present invention is not limited to the above-described exemplary embodiments. The form and details of the present invention can be changed within the scope of the present invention in various manners that can be understood by those skilled in the art.

### REFERENCE SIGNS LIST

100 communication system
200 base station
210 antenna
220 transceiver circuit
230 network interface
240 arithmetic processing unit
241 assignment unit
242 execution content data acquisition unit
243 contribution degree calculation unit
244 rewarding unit
250 storage unit
251 execution content information
252 program
300 terminal apparatus
310 antenna
320 transceiver circuit
330 user interface
340 arithmetic processing unit
341 processing execution unit
342 execution content data transmission unit
343 reward information reception unit
350 storage unit
352 execution content information
352 program
400 processing apparatus
500 processing apparatus
501 CPU
502 ROM
503 RAM
504 program group
505 storage device
506 drive device
507 communication interface
508 input/output interface
509 bus
510 recording medium
511 communication network
521 rewarding unit

1. A processing apparatus comprising:
at least one memory configured to store processing instructions; and
at least one processor configured to execute the processing instructions to:
determine a reward to provide to a terminal apparatus that performs target processing, which is processing contributive to a reduction in power consumption in a communication system using a base station, according to assignment from the base station, and provide the determined reward.

2. The processing apparatus according to claim 1, wherein
the at least one processor is configured to execute the processing instructions to:
assign the target processing to the terminal apparatus; and
provide the predetermined reward to the terminal apparatus that performs the assigned target processing.

3. The processing apparatus according to claim 2, wherein
the at least one processor is configured to execute the processing instructions to:
assign processing that assists the base station by being performed by the terminal apparatus as the target processing.

4. The processing apparatus according to claim 2, wherein
the at least one processor is configured to execute the processing instructions to:
assign processing for relaying a UL (uplink) signal from UE (User Equipment) present on a cell edge as the target processing.

5. The processing apparatus according to claim 2, wherein
the at least one processor is configured to execute the processing instructions to:
provide the reward according to a type of the assigned target processing.

6. The processing apparatus according to claim 1, wherein
the at least one processor is configured to execute the processing instructions to:
calculate a contribution degree indicating how large contribution the terminal apparatus makes by performing the target processing based on data acquired when the terminal apparatus performs the target processing; and
provide the reward according to the calculated contribution degree.

7. The processing apparatus according to claim 6, wherein
the at least one processor is configured to execute the processing instructions to:
acquire execution content data, the execution content data being data that can be acquired from the terminal apparatus when the target processing is performed; and
calculate the contribution degree based on the acquired data.

8. The processing apparatus according to claim 7, wherein
the at least one processor is configured to execute the processing instructions to:
acquire load information, which indicates a load on the terminal apparatus that is imposed when the target processing is performed, from the terminal apparatus as the execution content data.

9. A processing method configured to be performed by an information processing apparatus, the processing method comprising:
determining a reward to provide to a terminal apparatus that performs target processing, which is processing contributive to a reduction in power consumption in a communication system using a base station, according to assignment from the base station, and providing the determined reward.

10. A non-transitory computer-readable recording medium recording thereon a program for causing an information processing apparatus to realize processing comprising:
determining a reward to provide to a terminal apparatus that performs target processing, which is processing contributive to a reduction in power consumption in a communication system using a base station, according to assignment from the base station, and providing the determined reward.
